(19) United States
(12) Patent Application Publication
(10) Pub. No.: US 2025/0150221 A1
(43) Pub. Date: May 8, 2025

(54) SYSTEMS AND METHODS FOR DETERMINING DOWNLINK/UPLINK TIMING

(71) Applicant: ZTE CORPORATION, Shenzhen (CN)

(72) Inventors: Hanqing XU, Shenzhen (CN); Nan ZHANG, Shenzhen (CN); Ziyang LI, Shenzhen (CN); Wei CAO, Shenzhen (CN)

(73) Assignee: ZTE CORPORATION, Shenzhen (CN)

(21) Appl. No.: 19/015,917

(22) Filed: Jan. 10, 2025

Related U.S. Application Data
(63) Continuation of application No. PCT/CN2022/111236, filed on Aug. 9, 2022.

(51) Int. Cl. H04L 5/00

(52) U.S. Cl. CPC H04L 5/0005; H04L 5/0044

(57) ABSTRACT

Presented are systems and methods for determining downlink/uplink timing. A network node may determine a downlink timing of a first link or a second link based on at least one of a first downlink timing or a second downlink timing. The first downlink timing may correspond to a first frequency band for the first link. The second downlink timing may correspond to a second frequency band for the second link. The network node may determine an uplink timing of the first link or the second link based on at least one of a first uplink timing or a second uplink timing. The first uplink timing may correspond to the first frequency band. The second uplink timing may correspond to the second frequency band.

### CROSS-REFERENCE TO RELATED APPLICATION

This application claims the benefit of priority under 35 U.S.C. § 120 as a continuation of PCT Patent Application No. PCT/CN2022/111236, filed on Aug. 9, 2022, the disclosure of which is incorporated herein by reference in its entirety.

### TECHNICAL FIELD

The disclosure relates generally to wireless communications, including but not limited to systems and methods for determining downlink/uplink timing.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A network node may determine a downlink timing of a first link or a second link based on at least one of a first downlink timing or a second downlink timing. The first downlink timing may correspond to a first frequency band for the first link. The second downlink timing may correspond to a second frequency band for the second link. The network node may determine an uplink timing of the first link or the second link based on at least one of a first uplink timing or a second uplink timing. The first uplink timing may correspond to the first frequency band. The second uplink timing may correspond to the second frequency band.

In some embodiments, the first link may comprise at least one of following links: a first communication link from a wireless communication node to the network node; or a second communication link from the network node to the wireless communication node. The second link may comprise at least one of following links: a first forwarding link from a wireless communication node to the network node; a second forwarding link from the network node to the wireless communication node; a third forwarding link from the network node to a wireless communication device; or a fourth forwarding link from the wireless communication device to the network node.

In some embodiments, a timing difference between the first downlink timing and the second downlink timing or between the first uplink timing and the second uplink timing can be predefined, measured by the network node, or received by the network node from a wireless communication node. The network node may report the timing difference, a subcarrier spacing associated with the timing difference, and/or frequency bands associated with the timing difference to the wireless communication node. The network node may receive information comprising at least one of: subcarrier spacings corresponding to the timing difference, or frequency bands corresponding to the timing difference from the wireless communication node. The timing difference, the subcarrier spacings, and/or the frequency bands can be indicated to the network node by the wireless communication node through at least one of: system information (e.g., in SIB1), a RRC signaling (e.g., dedicated signaling or common signaling), or a MAC CE and/or DCI signaling (e.g. UE specific DCI or a group common DCI). If it is indicated by a DCI signaling, the DCI signaling can be scrambled by a new SN specific, link specific, service-type specific, or SN logic unit specific RNTI. The timing difference, the subcarrier spacings, and/or the frequency bands can be indicated to the network node by Operation Administration and Maintenance (OAM). The timing difference can also be a timing advance (TA) difference between the first uplink timing and the second uplink timing. The timing difference can be used to determine the UL timing of the network node.

In some embodiments, the network node may obtain the first downlink timing based on receiving a downlink signal in the first frequency band. The network node may obtain the first uplink timing based on sending an uplink signal in the first frequency band. The network node may obtain the second downlink timing based on receiving the downlink signal in the second frequency band. The network node may obtain the second uplink timing based on sending the uplink signal in the second frequency band. The first uplink timing and/or the second uplink timing can be determined based on at least one of the following parameter: N_{TA,offset} of a timing advance offset, N_{TA} indicated by a timing advance command. In some embodiments, the network node may determine that the first downlink timing is the downlink timing. The network node may determine that the first uplink timing is the uplink timing. The network node may determine that the second downlink timing is the downlink timing. The network node may determine that the second uplink timing is the uplink timing.

In some embodiments, the network node may determine that the second downlink timing is the downlink timing. The network node may determine that the first uplink timing, combined with the timing difference, is the uplink timing. The network node may determine that the first downlink timing, combined with the timing difference, is the downlink timing. The network node may determine that the first uplink timing, combined with the timing difference, is the uplink timing. A timing advance can be configured based on the first uplink timing and the timing difference.

In some embodiments, the downlink timing of the second link can be aligned with the downlink timing of the first link. The uplink timing of the second link can be aligned with the uplink timing of the first link. One or more subcarrier spacings, that each satisfy a specific condition within a plurality of subcarrier spacings in the first or second frequency band, can be configured or allowed for the first link and/or the second link. In certain embodiments, specific condition can be that the configured or allowed subcarrier spacings may be larger than or equal to a certain subcarrier spacing (e.g., 60 kHz), or smaller than or equal to a certain subcarrier spacing (e.g., 60 kHz).

In some embodiments, the first/second DL/UL timing may refer to a reference time point that is obtained/measured by the network node. The network node may determine that the first DL/UL timing is the DL/UL timing, that is, the network node may use the timing obtained in the first frequency band as the actual reference time point for the DL/UL transmission or reception at the network node. In certain embodiments, the actual reference time point can be the same as the reference time point.

In some embodiments, the network node may determine that the second DL/UL timing is the DL/UL timing, that is, the network node may use the timing obtained in the second frequency band as the actual reference time point for the DL/UL transmission or reception at the network node. In certain embodiments, the actual reference time point can be the same as the reference time point.

In some embodiments, the network node may determine that the first DL timing combined with the timing difference is the DL timing, that is, the actual reference time point for the DL transmission or reception at the network node can be to advance or delay a timing difference on the basis of the first DL timing. In certain embodiments, there can be a timing difference between the actual reference time point and the reference time point.

In some embodiments, the network node may determine that the first UL timing combined with the timing difference is the UL timing, that is, the actual reference time point for the UL transmission or reception at the network node can be to advance or delay a timing difference on the basis of the first UL timing. In certain embodiments, there can be a timing difference between the actual reference time point and the reference time point.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a sequence diagram for determining downlink/uplink timing, in accordance with some embodiments of the present disclosure;

FIG. 4 illustrates a sequence diagram for determining downlink/uplink timing, in accordance with some embodiments of the present disclosure;

FIG. 5 illustrates a sequence diagram for determining downlink/uplink timing, in accordance with some embodiments of the present disclosure;

FIG. 6 illustrates a sequence diagram for determining downlink/uplink timing, in accordance with some embodiments of the present disclosure;

FIG. 7 illustrates a sequence diagram for determining downlink/uplink timing, in accordance with some embodiments of the present disclosure; and

FIG. 8 illustrates a flow diagram for determining downlink/uplink timing, in accordance with an embodiment of the present disclosure.

### DETAILED DESCRIPTION

### 1. Mobile Communication Technology and Environment

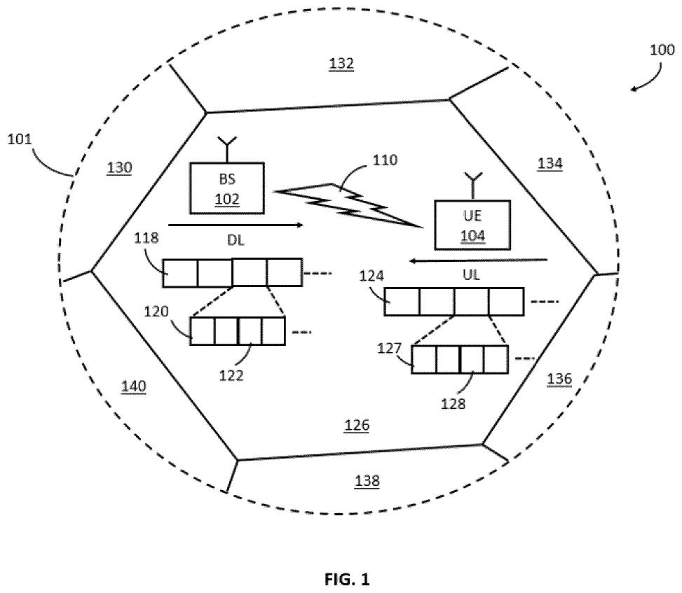

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

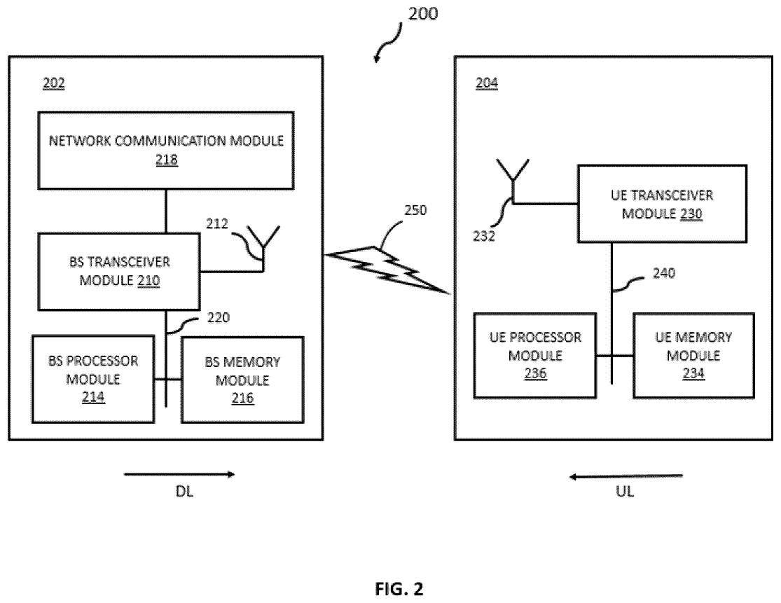

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Determining Downlink/Uplink Timing

In 3GPP, Release-18 (e.g., a network node, a network-controlled repeater (NCR)) is introduced as an enhancement over conventional radio frequency (RF) repeaters with a capability to receive and process side control information from a network. The network node may include but not limited to a network-controlled repeater (NCR), a smart repeater (SR), an enhanced RF repeater, a reconfiguration intelligent surface (RIS), or an integrated access and backhaul (IAB). The network node can be denoted as a smart node (SN) for simplicity. A SN can be a kind of network node to assist BS to improve coverage.

In some embodiments, a frequency band of communication/control link (C-link) (or SN communication/control unit (CU)) may not be in a same frequency band as that of forwarding link (F-link) (or SN forwarding unit (FU)). In other words, the above two operating frequency bands are out-of-band. As different frequency bands may use different subcarrier spacings. A corresponding timing advance (TA) granularity of different frequency bands can be different. Furthermore, timing requirements of different frequency bands can be also different (e.g, Te, TA adjustment accuracy). Therefore, if the operating frequency bands of C-Link and F-link are out-of-band, there may be a timing difference between the C-link and the F-link.

A FU may only include a RF unit. The FU cannot detect a signal to obtain timing synchronization. If a CU controls a FU forwarding based on timing of a C-link (e.g., ON/OFF, beam management, and/or power control), it may cause resource collision, interference, and/or performance loss since the timing of C-link is inaccurate for an F-link. Therefore, we need to design/investigate a mechanism to obtain an accurate timing of an F-link in order to accurately control a forwarding of FU.

Coverage can be a fundamental aspect of cellular network deployments. Mobile operators may rely on different types of network nodes to offer blanket coverage in the deployments. Therefore, new types of network nodes have been considered to increase mobile operators' flexibility for the network deployments. For example, integrated access and backhaul (IAB) was introduced in Release-16 and enhanced in Release-17 as a new type of network node not requiring a wired backhaul. Another type of network node is a RF repeater which may amplify-and-forward any received signals. The RF repeaters may have seen a wide range of deployments in 2G, 3G and 4G to supplement the coverage provided by regular full-stack cells. The RF repeater may only have a radio unit.

In Release-18, a network-controlled repeater is introduced as an enhancement over conventional RF repeaters with a capability to receive and process side control information from the network. The side control information may allow a network-controlled repeater to perform an amplify-and-forward operation in a more efficient manner. The advantages may include mitigation of unnecessary noise amplification, transmissions and receptions with better spatial directivity, and/or simplified network integration. Same mechanisms for controlling specified in this disclosure can also be applied to other product including RIS re-configuration intelligent surface (RIS).

The smart node (SN)/network node can comprise two units (or function entity) to support different functions: a first unit and a second unit respectively. The first unit may receive and may decode side control information from a base station (BS). The first unit can be a communication/control unit (CU), a mobile terminal (MT), part of UE, and/or a third-party Internet of Things (IoT) device. The second unit may perform/conduct/carry out an intelligent amplify-and-forward operation using the side control information received by the first unit of the SN. The second unit can be a forwarding unit (FU), a radio unit (RU), and/or a RIS. In this disclosure, the smart node/network node may be simply referred as SN. The communication/control unit (CU) and the forwarding unit (FU) may be referred as the first unit of the SN and the second unit of the SN respectively.

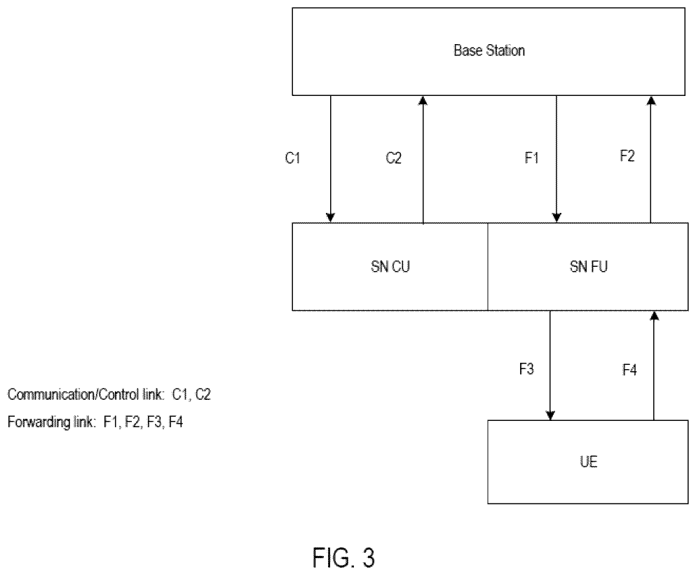

Referring now to FIG. 3, depicted is a configuration of an example of transmission links between a BS to a SN and a SN to a UE. C1 can be a communication link (or a control link) (CL) from the BS to the SN CU. C2 can be a communication/control link from the SN CU to the BS. F1 can be a forwarding link from the BS to the SN FU. F2 can be a forwarding link from the SN FU to the BS. F3 can be a forwarding link from the SN FU to the UE. F4 can be a forwarding link from the UE to the SN FU. In some embodiments, a communication link may mean/indicate a signal from one side (e.g., BS or SN CU) can be detected and be decoded by the other side (e.g., SN CU or BS). Information transmitting in the communication link can be utilized to control a status of forwarding links. A forwarding link may mean/indicate a signal from the BS or the UE can be unknown by the SN FU. The SN FU may simply amplify and forward signals without decoding the signals. F1+F3 is a complete DL forwarding link from the BS to the UE, in which F3 is the SN FU DL forwarding link. F2+F4 is a complete uplink (UL) forwarding link from the UE to the BS, in which F2 is the SN FU UL forwarding link.

F1 and/or F2 can also be called backhaul link (B-link). F3 and/or F4 can also be called access link (A-link).

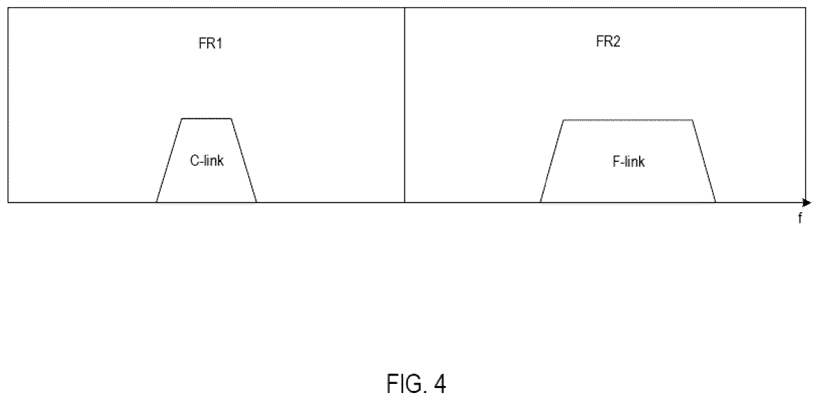

In some embodiments, a frequency band of communication/control link (C-link) (or SN communication/control unit (CU)) may not be in a same frequency band as that of forwarding link (F-link) (or SN forwarding unit (FU)). In other words, the above two operating frequency bands are out-of-band. For example, as shown in FIG. 4, a C-link may work in frequency range 1 (FR1) for initial access to control the forwarding of F-link. An F-link may work in frequency range 2 (FR2) for extension of network coverage on FR2 band.

In this disclosure, two frequency bands are out-of-band at least including one of the following cases: the two frequency bands are different carriers; the two frequency bands are located in different frequency bands; the two frequency bands are in different frequency ranges (e.g., FR1, FR2 (FR2-1, FR2-2)).

As different frequency bands may use different subcarrier spacings, the corresponding timing advance (TA) granularity can be different. Furthermore, the timing requirements of different frequency bands can also be different (e.g., Te, TA adjustment accuracy). If the operating frequency bands of the C-Link and the F-link are out-of-band, there may be a timing difference between the C-link and the F-link.

Assuming that a SN CU (or C-link) works in a first frequency band, the SN CU may at least obtain one of following timing. (a) A first downlink (DL) timing: the SN CU detects a DL signal (e.g., synchronization signal block (SSB)) transmitted by a base station in the first frequency band to obtain the first DL timing, that is, adopting a UE mechanism to obtain the first DL timing. (b) A first uplink (UL) timing: the SN CU obtains a first UL timing according to a UL signal (e.g., random access channel (RACH)) transmitted by a CU in the first frequency band, that is, adopting a UE mechanism to obtain the first UL timing.

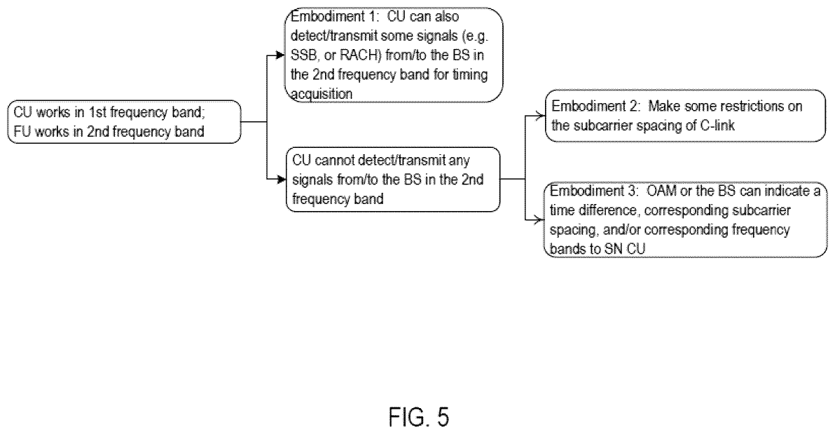

In some embodiments, the downlink (DL) timing may refer to an actual reference time point for the DL transmission or reception at the SN (e.g., the start of DL frame/subframe/slot at the SN). The DL timing may at least include one of: downlink reception timing or downlink transmission timing. In some embodiments, the uplink (UL) timing may refer to an actual reference time point for the UL transmission or reception at the SN (e.g., the start of UL frame/subframe/slot at the SN), which is located T_{TA} before the start of the corresponding DL frame at the SN. T_{TA} can be determined based on at least one of the following parameters: N_{TA,offset} of a timing advance offset, N_{TA} indicated by a timing advance command. The UL timing may at least include one of: uplink reception timing or uplink transmission timing. An overall structure of this disclosure is shown in FIG. 5.

### Implementation Example 1

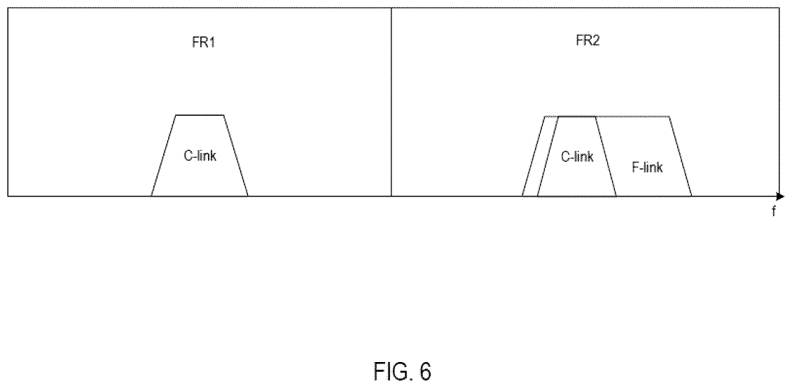

A smart node (SN) communication/control unit (CU) (or C-link) may mainly work in a first frequency band for initial access and/or control information reception/transmission. However, the SN may also detect/transmit some signals (e.g. synchronization signal block (SSB), or random access channel (RACH)) from/to a base station in a second frequency band for timing acquisition. A SN forwarding unit (FU) (or F-link) may work in the second frequency band for forwarding. An example is shown in the FIG. 6.

A second downlink (DL) timing: A SN CU may detect a DL signal (e.g., SSB) transmitted by a base station in the second frequency band to obtain a second DL timing. Alternatively, the SSB transmitted by the base station in the second frequency band can be only used for obtaining radio frame timing and/or system frame number (SFN) of the SN CU. In certain embodiments, the DL signal may not be used for other purposes (e.g., measurements).

A second uplink (UL) timing: A SN CU may obtain a second UL timing according to a UL signal (e.g., RACH) transmitted by the CU in the second frequency band. Optionally, the UL signal transmitted by SN CU in the second frequency band can be only used for obtaining UL timing of the SN CU. In certain embodiments, the UL signals may not be used for other purposes (e.g., measurements).

### For the Timing of SN CU (or C-Link)

Option 1-1: the SN CU may use the first DL timing as the DL timing of the C-link, and/or the SN CU may use the first UL timing as the UL timing of the C-link.
Option 1-2: the SN CU may use the second DL timing as the DL timing of the C-link, and/or the SN CU may use the second UL timing as the UL timing of the C-link.
Option 1-3: the SN CU may use the first DL timing as the DL timing of the C-link, and/or the SN CU may use the second UL timing as the UL timing of the C-link.
Option 1-4: the SN CU may use the second DL timing as the DL timing of the C-link, and/or the SN CU may use the first UL timing as the UL timing of the C-link.
Option 1-5: the SN CU may use the second DL timing as the DL timing of the C-link, and/or the SN CU may use the first UL timing plus a first timing difference as the UL timing of the C-link. The first timing difference can be the difference between the first DL timing and the second DL timing. A new timing advance (TA) can be obtained or defined by the first UL timing (e.g., a TA obtained in first frequency band) plus the first timing difference. The SN CU can report the first timing difference and/or associated subcarrier spacing (SCS) to the base station.

### For the Timing of SN FU (or F-Link)

Option 2-1: The timing of SN FU can be aligned with the timing of CU, including: the DL timing of the FU is aligned with the DL timing of the CU, and/or the UL timing of the FU is aligned with the UL timing of the CU.
Option 2-2: The DL timing of the FU is aligned with the second DL timing, and/or the UL timing of the FU is aligned with the second UL timing, or the first UL timing plus the first timing difference.

### Implementation Example 2

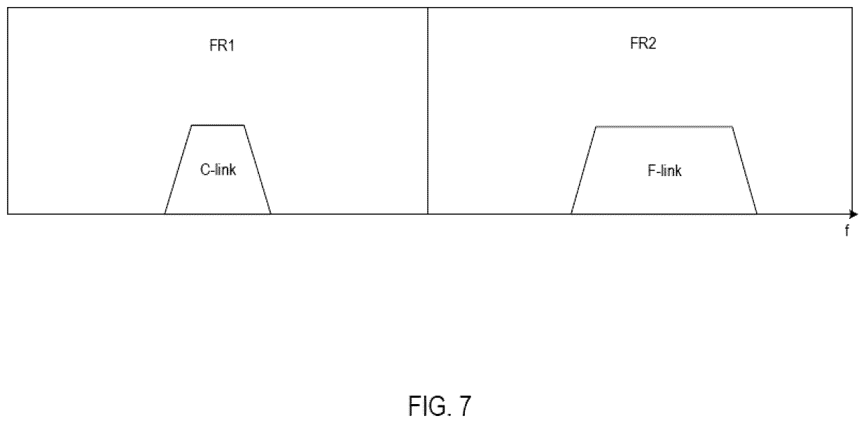

A communication/control unit (CU) (or C-link) may work in a first frequency band. A forwarding unit (FU) (or F-link) may work in a second frequency band. An example is shown in FIG. 7. The CU cannot detect synchronization signals transmitted by a base station in the second frequency band, and/or CU cannot transmit uplink signals in the second frequency band.

In this implementation example, for a timing of the SN CU (or C-link), the SN CU may use a first DL timing as a DL timing of the C-link, and/or the SN CU may use a first UL timing as the UL timing of the C-link (i.e., Option 1-1 in implementation example 1).

From timing requirements, it can be seen/observed from the two frequency bands. The closer their subcarrier spacing size is, the smaller the timing difference of the two frequency bands is. As a CU may generally work in a low frequency band for initial access and control information reception/transmission, a FU may generally work in a high frequency band for extension of network coverage. Therefore, the larger the subcarrier spacing of C-link operating in the first frequency band, the smaller timing difference between the C-link and the F-link.

Therefore, in order to reduce the timing difference between the C-link and the F-link, one of the following restrictions may need to be made on a subcarrier spacing of the SN CU (or C-link). (a) An operations, administration and maintenance (OAM) or a base station can configure one or more larger subcarrier spacings among supported subcarrier spacings in first frequency band for C-link. (b) Only one or more larger subcarrier spacings among supported subcarrier spacings in first frequency band can be allowed for C-link.

For example, the subcarrier spacing of SSB in the C-link can be configured/preset as 30 kHz, which is maximum subcarrier spacing of SSB in FR1. The subcarrier spacing of UL signal/channel in C-link can be configured/preset as 60 kHz, which is maximum subcarrier spacing of signals/channels in FR1.

Furthermore, in this implementation example, the timing of FU (or F-link) can be aligned with the timing of CU (or C-link), including (i.e. Option 2-1 implementation example 1): the DL timing of FU is aligned with the DL timing of the CU, and/or the UL timing of FU is aligned with the UL timing of the CU.

### Implementation Example 3

An OAM or a base station can store a table of the second timing differences. One second timing difference is a timing difference between two frequency bands (e.g., the DL timing in first frequency band and the DL timing in second frequency band). The table can include the second timing differences and/or one or more of the following information: a frequency band, or a SCS.

The OAM or base station can indicate a second timing difference, a corresponding subcarrier spacing, and/or corresponding frequency bands to the SN CU. The indication can be carried by system information, a radio resource control (RRC) signaling, a medium access control (MAC) control element (CE) and/or a downlink control information (DCI) signaling.

### For the Timing of SN CU (or C-Link)

Option 1-1: the SN CU may use the first DL timing as the DL timing of the C-link, and/or the SN CU may use the first UL timing as the UL timing of the C-link.
Option 1-6: the SN CU may use the first DL timing plus the second timing difference as the DL timing of the C-link, and/or the SN CU may use the first UL timing plus the second timing difference as the UL timing of the C-link. A new TA can be obtained or defined by the first UL timing (e.g., a TA obtained in first frequency band) plus the first timing difference.

### For the Timing of SN FU (or F-Link)

Option 2-1: the timing of SN FU can be aligned with the timing of CU, including: The DL timing of FU is aligned with the DL timing of the CU, and/or the UL timing of FU is aligned with the UL timing of the CU.
Option 2-3: the DL timing of FU is aligned with the first DL timing plus the second timing difference, and/or the UL timing of FU is aligned with the first UL timing plus the second timing difference.

It should be understood that one or more features from the above implementation examples are not exclusive to the specific implementation examples, but can be combined in any manner (e.g., in any priority and/or order, concurrently or otherwise).

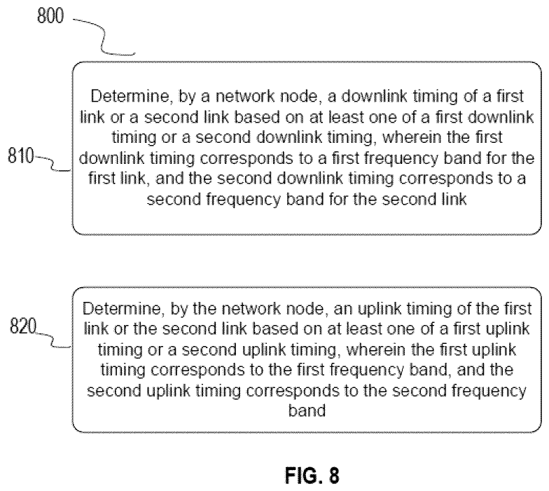

FIG. 8 illustrates a flow diagram of a method 800 for determining downlink/uplink timing. The method 800 may be implemented using any one or more of the components and devices detailed herein in conjunction with FIGS. 1-2. In overview, the method 800 may be performed by a control unit of a network node, in some embodiments. Additional, fewer, or different operations may be performed in the method 800 depending on the embodiment. At least one aspect of the operations is directed to a system, method, apparatus, or a computer-readable medium.

A network node may determine a downlink timing of a first link or a second link based on at least one of a first downlink timing or a second downlink timing. The first downlink timing may correspond to a first frequency band for the first link. The second downlink timing may correspond to a second frequency band for the second link. The network node may determine an uplink timing of the first link or the second link based on at least one of a first uplink timing or a second uplink timing. The first uplink timing may correspond to the first frequency band. The second uplink timing may correspond to the second frequency band.

In some embodiments, the first link may comprise at least one of following links: a first communication link from a wireless communication node to the network node; or a second communication link from the network node to the wireless communication node. The second link may comprise at least one of following links: a first forwarding link from a wireless communication node to the network node; a second forwarding link from the network node to the wireless communication node; a third forwarding link from the network node to a wireless communication device; or a fourth forwarding link from the wireless communication device to the network node.

In some embodiments, a timing difference between the first downlink timing and the second downlink timing or between the first uplink timing and the second uplink timing can be predefined, measured by the network node, or received by the network node from a wireless communication node. The network node may report the timing difference, a subcarrier spacing associated with the timing difference, and/or frequency bands associated with the timing difference to the wireless communication node. The network node may receive information comprising at least one of: subcarrier spacings corresponding to the timing difference, or frequency bands corresponding to the timing difference from the wireless communication node.

In some embodiments, the network node may obtain the first downlink timing based on receiving a downlink signal in the first frequency band. The network node may obtain the first uplink timing based on sending an uplink signal in the first frequency band. The network node may obtain the second downlink timing based on receiving the downlink signal in the second frequency band. The network node may obtain the second uplink timing based on sending the uplink signal in the second frequency band. The first uplink timing and/or the second uplink timing can be determined based on at least one of the following parameter: N_{TA,offset} of a timing advance offset, N_{TA} indicated by a timing advance command.

In some embodiments, the network node may determine that the first downlink timing is the downlink timing. The network node may determine that the first uplink timing is the uplink timing. The network node may determine that the second downlink timing is the downlink timing. The network node may determine that the second uplink timing is the uplink timing.

In some embodiments, the network node may determine that the second downlink timing is the downlink timing. The network node may determine that the first uplink timing, combined with the timing difference, is the uplink timing. The network node may determine that the first downlink timing, combined with the timing difference, is the downlink timing. The network node may determine that the first uplink timing, combined with the timing difference, is the uplink timing. A timing advance can be configured based on the first uplink timing and the timing difference.

In some embodiments, the downlink timing of the second link can be aligned with the downlink timing of the first link. The uplink timing of the second link can be aligned with the uplink timing of the first link. One or more subcarrier spacings, that each satisfy a specific condition within a plurality of subcarrier spacings in the first or second frequency band, can be configured or allowed for the first link and/or the second link.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A wireless communication method, comprising:
determining, by a network node, a downlink timing of a first link or a second link based on at least one of a first downlink timing or a second downlink timing, wherein the first downlink timing corresponds to a first frequency band for the first link, and the second downlink timing corresponds to a second frequency band for the second link; and/or
determining, by the network node, an uplink timing of the first link or the second link based on at least one of a first uplink timing or a second uplink timing, wherein the first uplink timing corresponds to the first frequency band, and the second uplink timing corresponds to the second frequency band.

2. The wireless communication method of claim 1, wherein the first link comprises at least one of following links:
a first communication link from a wireless communication node to the network node; or
a second communication link from the network node to the wireless communication node.

3. The wireless communication method of claim 1, wherein the second link comprises at least one of following links:
a first forwarding link from a wireless communication node to the network node;
a second forwarding link from the network node to the wireless communication node;
a third forwarding link from the network node to a wireless communication device; or
a fourth forwarding link from the wireless communication device to the network node.

4. The wireless communication method of claim 1, wherein a timing difference between the first downlink timing and the second downlink timing or between the first uplink timing and the second uplink timing is predefined, measured by the network node, or received by the network node from a wireless communication node.

5. The wireless communication method of claim 4, further comprising reporting, by the network node to the wireless communication node, the timing difference, a subcarrier spacing associated with the timing difference, and/or frequency bands associated with the timing difference.

6. The wireless communication method of claim 4, further comprising receiving, by the network node from the wireless communication node, information comprising at least one of: subcarrier spacings corresponding to the timing difference, or frequency bands corresponding to the timing difference.

7. The wireless communication method of claim 1, further comprising:
obtaining, by the network node, the first downlink timing based on receiving a downlink signal in the first frequency band;
obtaining, by the network node, the first uplink timing based on sending an uplink signal in the first frequency band;
obtaining, by the network node, the second downlink timing based on receiving the downlink signal in the second frequency band; and/or
obtaining, by the network node, the second uplink timing based on sending the uplink signal in the second frequency band.

8. The wireless communication method of claim 1, wherein the first uplink timing and/or the second uplink timing is determined based on at least one of following parameters: N_{TA,offset} of a timing advance offset, or N_{TA} indicated by a timing advance command.

9. The wireless communication method of claim 1, further comprising:
determining, by the network node, that the first downlink timing is the downlink timing; and/or
determining, by the network node, that the first uplink timing is the uplink timing.

10. The wireless communication method of claim 1, further comprising:
determining, by the network node, that the second downlink timing is the downlink timing; and/or
determining, by the network node, that the second uplink timing is the uplink timing.

11. The wireless communication method of claim 1, further comprising:
determining, by the network node, that the second downlink timing is the downlink timing; and/or
determining, by the network node, that the first uplink timing, combined with the timing difference, is the uplink timing.

12. The wireless communication method of claim 1, further comprising:
determining, by the network node, that the first downlink timing, combined with the timing difference, is the downlink timing; and/or
determining, by the network node, that the first uplink timing, combined with the timing difference, is the uplink timing.

13. The wireless communication method of claim 4, wherein a timing advance is configured based on the first uplink timing and the timing difference.

14. The wireless communication method of claim 1, wherein the downlink timing of the second link is aligned with the downlink timing of the first link, and/or the uplink timing of the second link is aligned with the uplink timing of the first link.

15. The wireless communication method of claim 1, wherein one or more subcarrier spacings, that each satisfy a specific condition within a plurality of subcarrier spacings in the first or second frequency band, are configured or allowed for the first link and/or the second link.

16. A network node, comprising:
determining, by a network node, a downlink timing of a first link or a second link based on at least one of a first downlink timing or a second downlink timing, wherein the first downlink timing corresponds to a first frequency band for the first link, and the second downlink timing corresponds to a second frequency band for the second link; and/or
determining, by the network node, an uplink timing of the first link or the second link based on at least one of a first uplink timing or a second uplink timing, wherein the first uplink timing corresponds to the first frequency band, and the second uplink timing corresponds to the second frequency band.

17. The network node of claim 16, wherein the first link comprises at least one of following links:
a first communication link from a wireless communication node to the network node; or
a second communication link from the network node to the wireless communication node.

18. The network node of claim 16, wherein the second link comprises at least one of following links:
a first forwarding link from a wireless communication node to the network node;
a second forwarding link from the network node to the wireless communication node;
a third forwarding link from the network node to a wireless communication device; or
a fourth forwarding link from the wireless communication device to the network node.

19. The network node of claim 16, wherein a timing difference between the first downlink timing and the second downlink timing or between the first uplink timing and the second uplink timing is predefined, measured by the network node, or received by the network node from a wireless communication node.

20. The network node of claim 19, further comprising reporting, by the network node to the wireless communication node, the timing difference, a subcarrier spacing associated with the timing difference, and/or frequency bands associated with the timing difference.
